(19) United States
(12) Patent Application Publication
(10) Pub. No.: US 2015/0086265 A1
(43) Pub. Date: Mar. 26, 2015

(54) SERVICEABLE ALIGNING AND SELF-RETAINING ELASTIC ARRANGEMENT FOR MATED COMPONENTS AND METHOD

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US); Joel Colombo, Howell, MI (US)

(73) Assignee: GM GLOBAL TECHNOLOGY OPERATIONS LLC, Detroit, MI (US)

(21) Appl. No.: 14/038,241

(22) Filed: Sep. 26, 2013

(51) Int. Cl. F16B 17/00

(52) U.S. Cl. CPC F16B 17/002
USPC 403/280; 29/525

(57) ABSTRACT

A serviceable self-retaining elastic arrangement for mated components includes a first component having at least one protrusion having a retaining rib circumferentially extending around an outer surface of the at least one protrusion. Also included is a second component having at least one elastically deformable beam. Further included is at least one aperture defined by the at least one elastically deformable beam, the at least one aperture configured to receive the at least one protrusion therein and having at least one aperture dimension smaller than at least one protrusion dimension, wherein the at least one elastically deformable beam is elastically deformed in an engaged condition of the at least one protrusion with the at least one elastically deformable beam.

### FIELD OF THE INVENTION

The invention relates to components to be mated together and, more particularly, to a serviceable alignment and self-retaining elastic arrangement for mated components, as well as a method of retaining such components to each other.

### BACKGROUND

Currently, components which are to be mated together in a manufacturing process are subject to positional variation based on the mating arrangements between the components. One common arrangement includes components mutually located with respect to each other by 2-way and/or 4-way male alignment features; typically undersized male structures which are received into corresponding oversized female alignment features such as apertures in the form of openings and/or slots. Alternatively, double-sided tape, adhesives or welding processes may be employed to mate parts. Irrespective of the precise mating arrangement, there is a clearance between at least a portion of the alignment features which is predetermined to match anticipated size and positional variation tolerances of the mating features as a result of manufacturing (or fabrication) variances. As a result, occurrence of significant positional variation between the mated components is possible, which may contribute to the presence of undesirably large and varying gaps and otherwise poor fit. The clearance between the aligning and attaching features may lead to relative motion between mated components, which may contribute to poor perceived quality. Additional undesirable effects may include squeaking and rattling of the mated components, for example.

### SUMMARY OF THE INVENTION

In one exemplary embodiment, a serviceable self-retaining elastic arrangement for mated components includes a first component having at least one protrusion having a retaining rib circumferentially extending around an outer surface of the at least one elastically deformable protrusion. Also included is a second component having at least one elastically deformable beam. Further included is at least one aperture defined by the at least one elastically deformable beam, the at least one aperture configured to receive the at least one protrusion therein and having at least one aperture dimension smaller than at least one protrusion dimension, wherein the at least one elastically deformable beam is elastically deformed in an engaged condition of the at least one protrusion with the at least one elastically deformable beam.

In another exemplary embodiment, an elastic retaining assembly for instrument panel trim assembly of a vehicle includes a first trim component having a tubular protrusion extending therefrom, the tubular protrusion having a retaining rib circumferentially extending around an outer surface of the tubular protrusion. Also included is a second trim component having a first elastically deformable beam and a second elastically deformable beam. Further included is an aperture defined by the first and second elastically deformable beams, the aperture configured to receive the tubular protrusion, wherein at least one of the first and second elastically deformable beams is elastically deformed in an engaged condition of the tubular protrusion with the first and second elastically deformable beams.

In yet another exemplary embodiment, a method of retaining mated components of an instrument panel trim assembly is provided. The method includes inserting a tubular protrusion extending from a first trim component into an aperture of a second component, the aperture defined by a first elastically deformable beam and a second elastically deformable beam. The method also includes engaging the tubular protrusion with the first and second elastically deformable beam upon insertion of the tubular protrusion into the aperture. The method further includes elastically deforming at least one of the first and second elastically deformable beams upon insertion of the tubular protrusion to a fully engaged condition.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a first component of an elastic retaining arrangement;

FIG. 2 is a perspective view of a first embodiment of a second component of the elastic retaining arrangement;

FIG. 3 is a plan view of the first component and the second component in an engaged condition;

FIG. 4 is a cross-sectional view of the first component engaged with the second component taken along line 4-4 of FIG. 3;

FIG. 5 is a perspective view of the first component engaged with a second embodiment of the second component of the elastic retaining arrangement; and

FIG. 6 is a flow diagram illustrating a method of retaining mated components.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

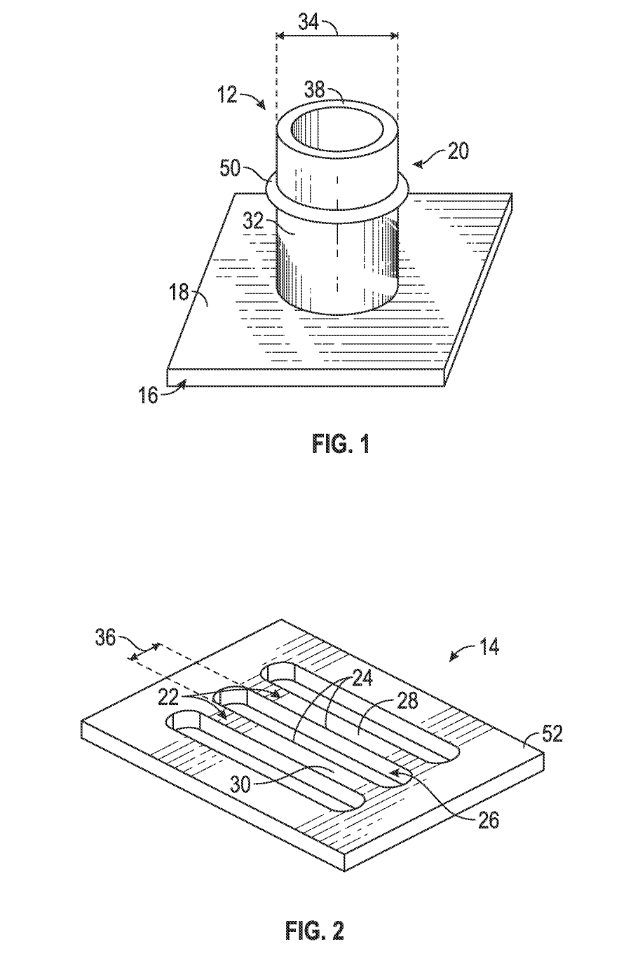

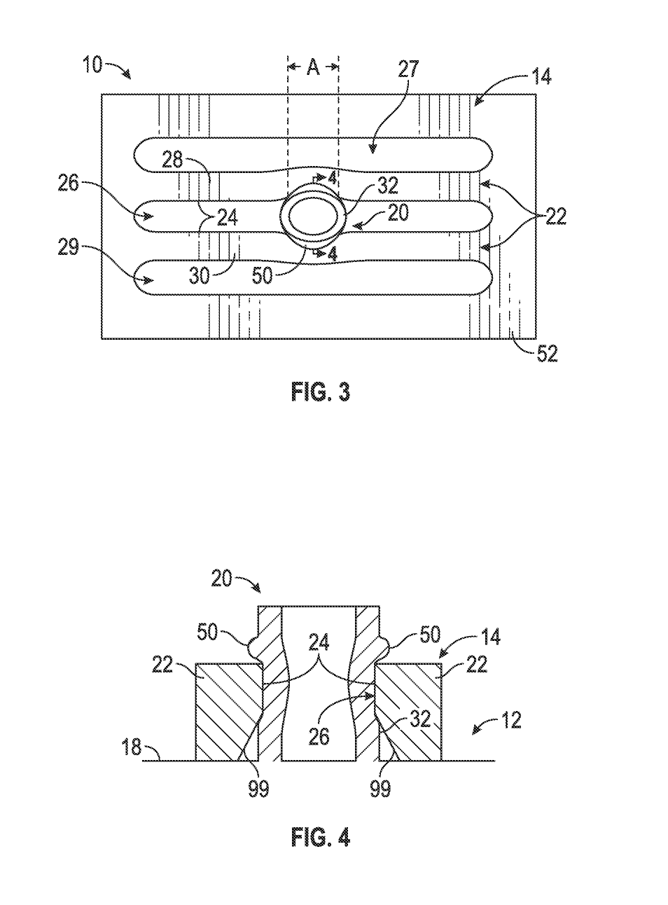

FIGS. 1 and 2, in combination, illustrate an alignment and retaining arrangement 10 (FIG. 3). The retaining arrangement 10 comprises components configured to be engaged or mated with each other, such as a first component 12 and a second component 14. The alignment and retaining arrangement 10 may be associated with numerous applications and industries, such as home appliance and aerospace applications, for example. In one embodiment, the alignment and retaining arrangement 10 is employed in a vehicle, such as an automobile. In an automobile embodiment, the alignment and retaining arrangement 10 may comprise an instrument panel (IP) arrangement. Various IP arrangements are contemplated, including a trim component mated to another trim component or a trim component mated directly to the instrument panel. Additionally, various emblems may employ embodiments of the alignment and retaining arrangement 10 described herein. As will be appreciated from the description herein, embodiments of the alignment and retaining arrangement 10 may be used in any application that benefits from a reduction or elimination of gaps that may result in vibration and noise or poor appearance.

The first component 12 (FIG. 1) includes a main portion 16 having a first surface 18 that is typically a substantially planar surface. The first component 12 also includes a protrusion 20 extending from the main portion 16 in a direction relatively orthogonal from a plane that the first surface 18 is disposed in. The protrusion 20 is operatively coupled to the main portion 16 and may be integrally formed with the main portion 16. The protrusion 20 may be formed as numerous contemplated embodiments. In the exemplary embodiment, the protrusion 20 comprises a tubular member. In another embodiment, the protrusion 20 may be a solid cylindrical member. Other embodiments include non-circular cross-sectional geometries. The preceding embodiment descriptions are merely illustrative and are not intended to be limiting of the numerous shapes that the protrusion 20 may be comprised of

A first embodiment of the second component 14 (FIG. 2) includes a plurality of elastically deformable beams 22 that are disposed substantially parallel to each other. The plurality of elastically deformable beams 22 includes edges 24 that define at least one aperture 26. In the illustrated embodiment, a first elastically deformable beam 28 and a second elastically deformable beam 30 are illustrated, however, it is to be understood that the precise number of beams may vary. As such, the number of apertures may vary as well. For purposes of discussion, only the first and second elastically deformable beams 28, 30, as well as the aperture 26 will be described in detail. Similarly, although a single protrusion is illustrated, embodiments of the retaining arrangement 10 may include a plurality of protrusions, as will be described in detail below.

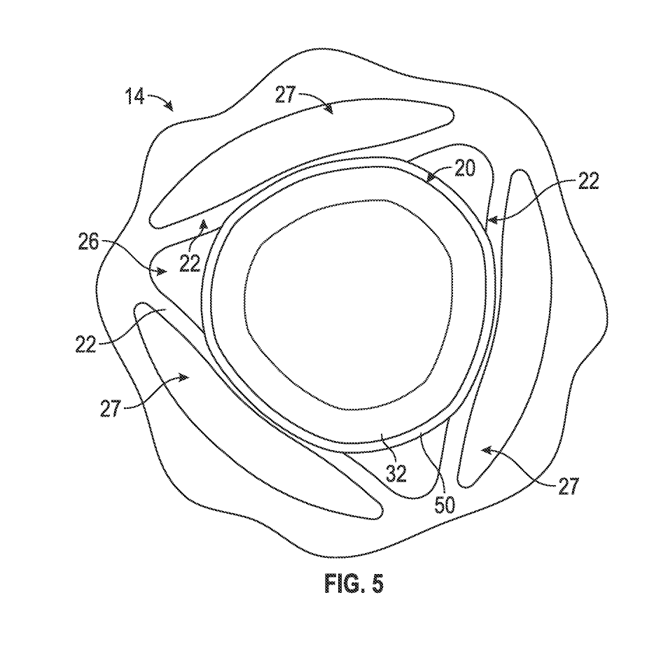

Referring now to FIG. 3, with continued reference to FIGS. 1 and 2, the protrusion 20 is illustrated in an engaged condition with the at least one aperture 26. Specifically, the protrusion 20 is inserted into the at least one aperture 26, with an outer surface 32 of the protrusion 20 in contact with a portion of the edges 24 of the elastically deformable beams 22, namely the first and second elastically deformable beams 28, 30. Contact between the edges 24 and the outer surface 32 of the protrusion 20 is ensured due to at least one dimension 34 of the protrusion 20 being greater than a width 36 of the aperture 26, as shown in FIG. 1. In the illustrated embodiment, the at least one dimension 34 of the protrusion 20 refers to a protrusion diameter. In other embodiments comprising non-circular cross-sectional geometries of the protrusion 20, the at least one dimension 34 corresponds to a length, width, or the like. To facilitate insertion of the protrusion 20 into the aperture 26, a “lead-in,” or guide portion 99 (FIG. 4) may be included. The guide portion 99 may be located on a surface of the second component 14 proximate the edges 24 of the elastically deformable beams 22, as shown. Alternatively, the guide portion may be an angled region (not shown) spanning at least a portion of an end 38 of the protrusion 20 may be included to avoid engagement of two blunt objects, which may preclude insertion of the protrusion 20.

The illustrated embodiment includes a rib 50 that extends around, and protrudes from, the outer surface 32 of the protrusion 20. Although the rib 50 is shown to fully extend around the outer surface 32 of the protrusion 20, it is to be appreciated that the rib 50 may be located intermittently about the circumference of the outer surface 32. Insertion of the protrusion 20 into the aperture 26 ultimately leads to a fully engaged position of the protrusion 20. The fully engaged position corresponds to a “snapping” of the rib 50 over a surface 52 of the second component 14 upon complete passing through the aperture 26 by the rib 50. The fully engaged position provides a tight, fitted engagement between the protrusion 20 and the elastically deformable beams 22 that is achieved by contact interface between the outer surface 32 and the edges 24 of the elastically deformable beams 22. Such a condition is ensured by sizing the protrusion to have a larger dimension than the width of the aperture 26, as described above in detail. The malleability of the materials reduces issues associated with positional variance. More particularly, in contrast to a rigid insert that typically requires gaps between the insert and receiving structure at portions around the perimeter or outer surface of the insert, the elastically deformable beams 22, and optionally the protrusion 20, advantageously deform to maintain alignment of the first component 12 and the second component 14, while also reducing or eliminating gaps associated with manufacturing challenges. Additionally, the fully engaged position of the first component 12 with the second component 14 provides a retaining force that reduces or eliminates the need for additional retaining features. The elastically deformable nature of the beams allows for removal of the protrusion 20 for service functions.

As will be apparent from the description herein, the elastically deformable beams 22 of the second component 14, in combination with the particular orientations described above, facilitates precise alignment/location of the first component 12 relative to the second component 14 by accounting for positional variation of the retaining and locating features of the first component 12 and the second component 14 inherently present due to manufacturing processes. Additionally, the interference condition imposed between the protrusion 20 and the edges 24 of the aperture 26 provide a self-retaining force for the first and second components 12, 14. The deforming beams provide a greater surface area for engagement between the components and allow a longer rib engagement for the retention of the male part to the female part. It is to be appreciated that the protrusion 20 may also be formed of an elastically deformable material.

The protrusion 20 of the first component 12 is positioned and engaged with the edges 24 that define the aperture 26 of the second component 14 upon translation of the first component 12 toward the second component 14. Full engagement occurs when the rib 50 is pushed through the aperture 26. In this way, the first component 12 is press fit into the second component 14 upon engagement of the protrusion 20 with the edges 24. More particularly, an outer surface 32 of the protrusion 20 engages the edges 24 of the first and second elastically deformable beams 28, 30. A void of material (apertures 27, 29) proximate elastically deformable beams 22 enable flexibility of the elastically deformable beams 22, thereby facilitating deflection of the beams. The two beam embodiment illustrated provides 2-way locating of the protrusion 20.

Referring now to FIG. 5, the second component 14 is illustrated according to an alternate embodiment. Specifically, the elastically deformable beams 22 of the second component 14 are disposed in a substantially non-parallel relationship with each other. In the illustrated embodiment, three beams are shown in a triangular configuration. In one embodiment, the elastically deformable beams are disposed at an acute angle relative to each other. As with the first embodiment of the second component 14 described above, the elastically deformable beams 22 at least partially define aperture 26. The void of material in the form of the apertures 27, and center aperture 26, combined with the elastically deformable material comprising the elastically deformable beams 22, facilitates the deformation and/or deflection of the beams upon insertion of the protrusion 20, as described in detail above. The three beam embodiment illustrated provides four-way locating of the protrusion 20 (i.e., in an X-Y plane shown in FIG. 1). As noted above, the protrusion is fully engaged upon passing of the rib 50 in a direction Z over the mating component 14.

Any suitable elastically deformable material may be used to construct the elastically deformable beams 22 and the protrusion 20 for embodiments comprising an elastically deformable protrusion. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the elastically deformable beams 22 and the protrusion 20 for embodiments comprising an elastically deformable protrusion. The predetermined elastic response characteristic may include, for example, a predetermined elastic modulus.

It is contemplated that the first component 12 may include a plurality of protrusions, while the second component 14 may include any number of elastically deformable beams 22, and therefore any number of apertures 26. In some embodiments, the elastic deformation of the plurality of elastically deformable beams 22, and possibly the protrusions, elastically averages any positional errors of the first component 12 and the second component 14. In other words, gaps that would otherwise be present due to positional errors associated with portions or segments of the first component 12 and the second component 14, particularly locating and retaining features, are eliminated by offsetting the gaps with an over-constrained condition of other beams or protrusions. Specifically, the positional variance of each protrusion and/or beams is offset by the remaining protrusions or beams to average, in aggregate, the positional variance of the features.

Elastic averaging provides elastic deformation of the interface(s) between mated components, wherein the average deformation provides a precise alignment, the manufacturing positional variance being minimized to Xmin, defined by Xmin=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, now U.S. Publication No. U.S. 2013-0019455, the disclosure of which is incorporated by reference herein in its entirety. The embodiments disclosed above provide the ability to convert an existing component that is not compatible with the above-described elastic averaging principles, or that would be further aided with the inclusion of, to an assembly that does facilitate elastic averaging and the benefits associated therewith.

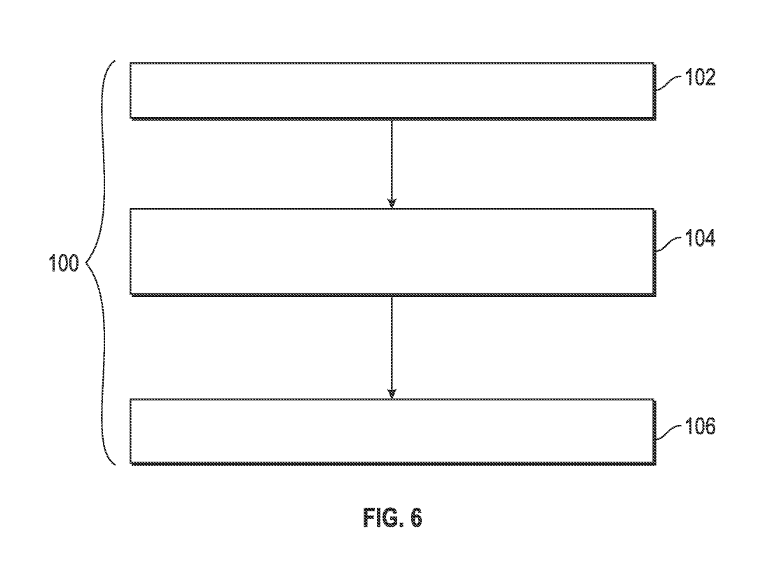

A method of retaining mated components 100 is also provided, as illustrated in FIG. 6, and with reference to FIGS. 1-5. The retaining arrangement 10, and more specifically the elastically deformable nature of the beams and possibly the protrusion, has been previously described and specific structural components need not be described in further detail. The method 100 includes inserting 102 the protrusion 20 into the aperture 26 of the second component 14. The protrusion 20 is engaged 104 with the plurality of elastically deformable beams 22 upon insertion 102 of the protrusion 20 into the aperture 26. The first and/or second elastically deformable beam is elastically deformed 106 upon insertion 102 of the protrusion to a fully engaged position or condition.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A serviceable self-retaining elastic arrangement for mated components, the arrangement comprising:
a first component having at least one elastically deformable protrusion having a retaining rib circumferentially extending around an outer surface of the at least one protrusion;
a second component having a plurality of elastically deformable beams; and
at least one aperture defined within the at least one elastically deformable beam, the at least one aperture configured to receive the at least one protrusion therein and having at least one aperture dimension smaller than at least one protrusion dimension, wherein the at least one elastically deformable beam is elastically deformed in an engaged condition of the at least one protrusion with the at least one elastically deformable beam.

2. The serviceable self-retaining elastic arrangement of claim 1, further comprising a plurality of elastically deformable beams.

3. The serviceable self-retaining elastic arrangement of claim 2, wherein the plurality of elastically deformable beams comprises a first elastically deformable beam and a second elastically deformable beam.

4. The serviceable self-retaining elastic arrangement of claim 3, wherein the first and second elastically deformable beams are disposed substantially parallel to each other.

5. The serviceable self-retaining elastic arrangement of claim 2, wherein the plurality of elastically deformable beams comprises a first elastically deformable beam, a second elastically deformable beam, and a third elastically deformable beam.

6. The serviceable self-retaining elastic arrangement of claim 5, wherein the first, second and third elastically deformable beams define a triangular aperture.

7. The serviceable self-retaining elastic arrangement of claim 5, wherein each of the first, second and third elastically deformable beams are disposed at an acute angle to each other.

8. The serviceable self-retaining arrangement of claim 1, wherein the at least one protrusion comprises a solid cylindrical member.

9. The serviceable self-retaining arrangement of claim 1, wherein the at least one protrusion comprises a substantially rigid tubular member.

10. The serviceable self-retaining arrangement of claim 1, wherein the at least one protrusion comprises an elastically deformable tubular member.

11. The serviceable self-retaining arrangement of claim 1, wherein the first and second components comprise instrument panel trim components for a vehicle.

12. The serviceable self-retaining arrangement of claim 1, wherein the first component has at least two elastically deformable protrusions and the second component has at least two apertures.

13. An elastic retaining assembly for instrument panel trim assembly of a vehicle, the arrangement comprising:
a first trim component having a tubular protrusion extending therefrom, the tubular protrusion having a retaining rib circumferentially extending about an outer surface of the tubular protrusion;
a second trim component having a first elastically deformable beam and a second elastically deformable beam; and
an aperture defined by the first and second elastically deformable beams, the aperture configured to receive the tubular protrusion, wherein at least one of the first and second elastically deformable beams is elastically deformed in an engaged condition of the tubular protrusion with the first and second elastically deformable beams.

14. The elastic retaining assembly of claim 13, wherein the first and second elastically deformable beams are disposed substantially parallel to each other.

15. The elastic retaining assembly of claim 13, further comprising a third elastically deformable beam, wherein the first, second and third elastically deformable beams define a triangular aperture.

16. The elastic retaining assembly of claim 15, wherein each of the first, second and third elastically deformable beams are disposed at an acute angle relative to each other.

17. The elastic retaining assembly of claim 13, wherein the tubular protrusion comprises a substantially rigid member.

18. The elastic retaining assembly of claim 13, wherein the tubular protrusion comprises an elastically deformable member.

19. The elastic retaining assembly of claim 13, wherein the aperture comprises a dimension smaller than at least one protrusion dimension.

20. A method of retaining mated components of an instrument panel trim assembly, the method comprising:
inserting a tubular protrusion extending from a first trim component into an aperture of a second component, the aperture defined by a first elastically deformable beam and a second elastically deformable beam;
engaging the tubular protrusion with the first and second elastically deformable beam upon insertion of the tubular protrusion into the aperture; and
elastically deforming at least one of the first and second elastically deformable beams upon insertion of the tubular protrusion to a fully engaged condition.
